(19) United States
(12) Patent Application Publication
(10) Pub. No.: US 2018/0123141 A1
(43) Pub. Date: May 3, 2018

(54) METAL BEAD WITH STAMPED COMPRESSION LIMITER

(71) Applicant: GM Global Technology Operations LLC, Detroit, MI (US)

(72) Inventors: Liang Xi, Northville, MI (US); Richard D. Blakeley, Ortonville, MI (US); Xi Yang, Bloomfield Hills, MI (US); Siguang Xu, Rochester Hills, MI (US); Ivan D. Chapman, Victor, NY (US); Yeh-Hung Lai, Oakland, MI (US)

(21) Appl. No.: 15/337,377

(22) Filed: Oct. 28, 2016

(51) Int. Cl. H01M 8/026; H01M 8/0254; H01M 8/24

(52) U.S. Cl. CPC H01M 8/026; H01M 8/24; H01M 8/0254

(57) ABSTRACT

A number of variations may include a product that may include a fuel cell stack assembly that may include at least one bipolar plate that may include at least one raised bead and at least one raised limiter.

### TECHNICAL FIELD

The field to which the disclosure generally relates includes bipolar plates.

### BACKGROUND

Fuel cells are electrochemical devices which combine a fuel such as hydrogen and an oxidant such as oxygen to produce electricity. The term fuel cell is typically used to refer to either a single cell or a plurality of cells depending upon the context in which it is used. The plurality of cells is typically bundled together and arranged to form a stack with the plurality of cells commonly arranged in electrical series.

In order to mitigate against undesirable leakage of fluids from between the plates, a seal is often used. The seal is disposed along a peripheral edge of the plates, and/or around a periphery of an aperture extending through the plates. The seal may include an elastomeric seal, or alternatively, the metal plates may be formed to define a raised bead seal. The raised bead may be formed on a planar metal sheet adjacent an outer edge of the sheet, or adjacent an edge surrounding an aperture formed in the sheet. The raised bead may be formed in the metal sheet by a stamping operation, although other methods may be used. The raised bead seal may be substantially symmetrical about a longitudinal center line of the raised bead seal. However, it should be appreciated that the raised bead seal may be non-symmetrical about the longitudinal center line. The raised bead seal may include a generally arcuate cross sectional shape perpendicular to the longitudinal center line. The generally arcuate cross sectional shape of the raised bead seal provides an elastic response to a load in a direction normal to the planar metal sheet.

The raised bead seal may be compressed against an adjoining plate to form a seal against the adjoining plate. If portions of the raised bead seal have a high stiffness, and others have a lower stiffness, the high stiffness areas of the raised bead seal may prevent the lower stiffness areas of the raised bead seal from forming a tight seal. Accordingly, the raised bead seals should have a uniform stiffness in all sections of the raised bead seal in order to form a tight seal around the entire peripheral edge of the plates and/or around the entire periphery of the adjacent aperture.

Bipolar plates may be used in, for example, fuel cell stacks and may include a sealing bead or sealing beads in parallel and a plurality of through-tunnels. Sealing beads may militate against fluid leakage from adjacent plates within a fuel cell stack and facilitate flow of reactants within the fuel cell stack. Under extreme loads, for example a vehicle crash, the bead may become over-compressed and lead to leaking within a fuel cell or failure of the fuel cell stack. The addition of at least one or more raised limiters may prevent over-compression and prevent leakage within a fuel cell or failure of the fuel cell stack.

### SUMMARY OF ILLUSTRATIVE VARIATIONS

A number of variations may include a product that may include a fuel cell stack assembly that may include at least one bipolar plate that may include at least one raised bead and at least one raised limiter.

A number of variations may include a product that may include a bipolar plate that may include at least one raised bead having a height “A” and at least one raised limiter having a height “B” wherein B is shorter than A.

A number of variations may include a product that may include a bipolar plate that may include at least one raised bead having a first height and at least one generally rib shaped raised limiter having a second height wherein the second height is shorter about 60 micrometers shorter than the first height.

A number of variations may include a product that may include a bipolar plate that may include at least one raised bead having a first height and a plurality of raised limiters having a second height wherein the second height is shorter about 60 micrometers shorter than the first height.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts one variation of a plan view of a fuel cell stack that may include a bipolar plate;

FIG. 2 depicts one variation of a cross-sectional view of a fuel cell stack that may include a bipolar plate;

FIG. 3 depicts one variation of a perspective view of a fuel cell stack that may include a bipolar plate that may include a raised limiter;

FIG. 4 depicts one variation of a perspective view of a fuel cell stack that may include a bipolar plate that may include a plurality of raised limiters; and

FIGS. 5A-5H depict variations of a plan view of a fuel cell stack that may include a bipolar plate that may include a plurality of raised limiters.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

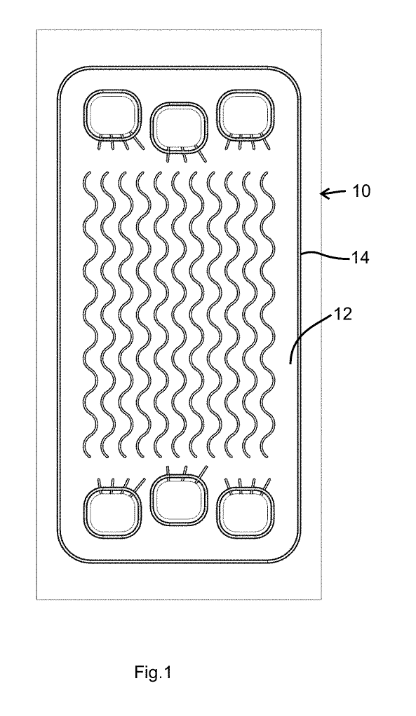

Referring to FIGS. 1-4; a fuel cell stack assembly 10 may include a bipolar plate 12 that may include at least one raised bead 14 having a first height A and at least one raised limiter 16 having a second height B wherein B may be shorter than A. In a number of variations the raised limiter 16 may have a height that is 30-100 micrometers shorter than the raised bead 16. The raised limited may have a variety of shapes. In a number of variations the raised limiter 16 may be generally ribbed shaped or semi-spherical shaped.

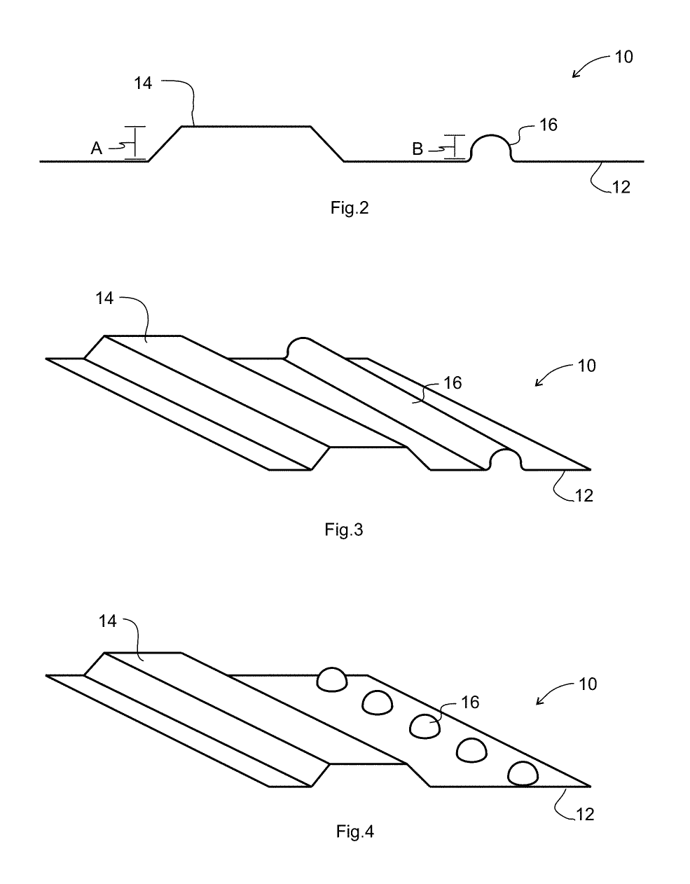

Referring to FIGS. 2-4; a fuel cell stack assembly 10 may include a bipolar plate 12 that may include at least one raised bead 14 having a first height A and at least one raised limiter 16 having a second height B wherein B may be shorter than A. The at least one raised limiter 16 may be a plurality of raised limiters 16.

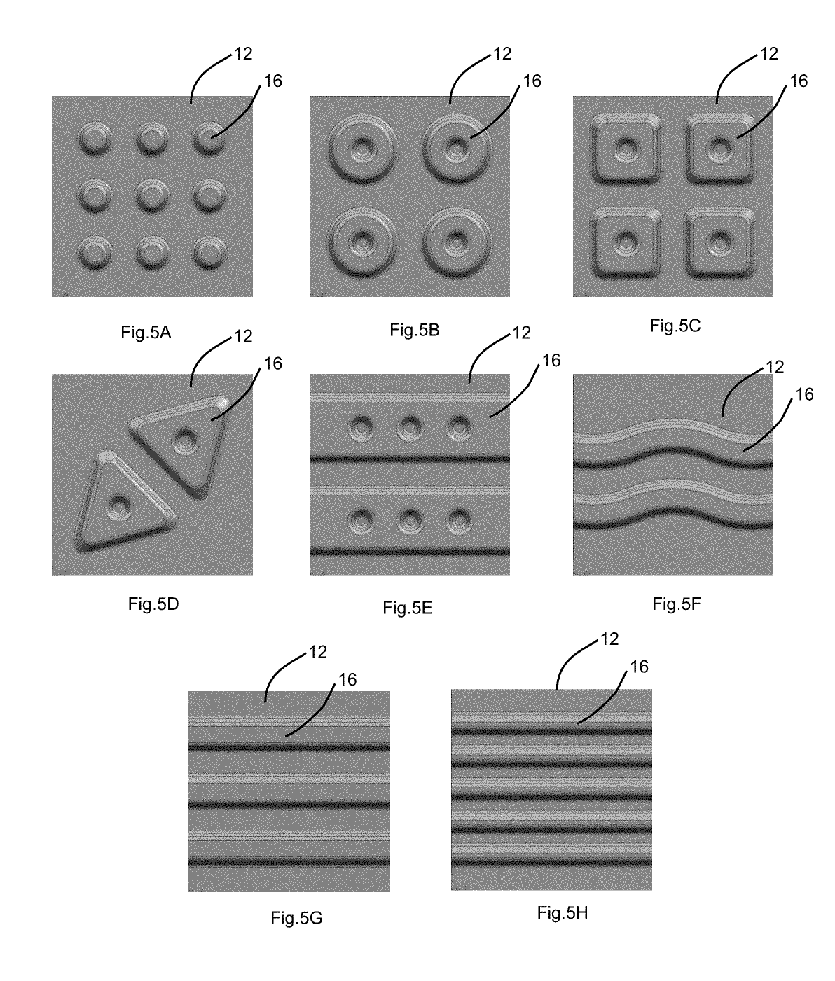

Referring to FIGS. 5A-5H; a fuel cell stack assembly 10 may include a bipolar plate 12 that may include at least one raised limiter 16. The at least one raised limiter 16 may be a plurality of raised limiters 16 having shapes such as, but not limited to, island shape (FIG. 5A), dimple shape (FIG. 5B-5E), or channel shape (FIG. 5F-5H).

As an example, a compression load of approximately 3.94 N/mm was applied to a bipolar plate having a raised bead. Vertical displacement of 107.3 micrometers of the raised bead was observed in the form or plastic and/or elastic deformation. Additionally, a compression load of approximately 3.94 N/mm was applied to a bipolar plate having a raised bead as well as at least one raised limiter about 60 micrometers shorter than the raised bead. Vertical displacement of 84.8 micrometers of the raised bead was observed in the form or plastic and/or elastic deformation. The above description is merely demonstrative in nature and, thus, variations thereof are not to be regarded as a departure from the spirit and scope of the inventions disclosed within this document.

According to variation 1, a product may include a fuel cell stack assembly may include at least one bi-polar plate including at least one raised bead and at least one raised limiter.

Variation 2 may include a product as set forth in variation 1 wherein the at least one raised bead may have a first height and the at least one raised limiter may have a second height wherein the second height may be shorter than the first height.

Variation 3 may include a product as set forth in variation 2 wherein the second height may be about 60 micrometers shorter than the first height.

Variation 4 may include a product as set forth in any of variations 1 through 3 wherein the at least one raised limiter may be generally ribbed shaped.

Variation 5 may include a product as set forth in any of variations 1 through 4 wherein the at least one raised limiter may be a plurality of raised limiters.

According to variation 6, a product may include a bi-polar plate that may include at least one raised bead having a first height and at least one raised limiter having a second height wherein the second height may be shorter than the first height.

Variation 7 may include a product as set forth in variation 6 wherein the at least one raised limiter may be generally ribbed shaped.

Variation 8 may include a product as set forth in any of variations 6 and 7 wherein the at least one raised limiter may be a plurality of raised limiters.

Variation 9 may include a product as set forth in any of variations 1 through 8 wherein the second height may be about 60 micrometers shorter than the first height.

According to variation 10, a product may include a bi-polar plate that may include at least one raised bead having a first height and at least one generally rib shaped raised limiter having a second height wherein the second height may be shorter about 60 micrometers shorter than the first height.

According to variation 11, a product may include a bi-polar plate that may include at least one raised bead having a first height and a plurality of raised limiters having a second height wherein the second height may be shorter about 60 micrometers shorter than the first height.

The above description of variations of the invention is merely demonstrative in nature and, thus, variations thereof are not to be regarded as a departure from the spirit and scope of the inventions disclosed within this document.

What is claimed is:

1. A product comprising:
a fuel cell stack assembly comprising at least one bipolar plate including at least one raised bead and at least one raised limiter.

2. A product as set forth in claim 1, wherein the at least one raised bead has a first height and the at least one raised limiter has a second height wherein the second height is shorter than the first height.

3. A product as set forth in claim 2, wherein the second height is about 60 micrometers shorter than the first height.

4. A product as set forth in claim 1, wherein the at least one raised limiter is generally ribbed shaped.

5. A product as set forth in claim 1, wherein the at least one raised limiter is a plurality of raised limiters.

6. A product comprising:
a bipolar plate that comprising at least one raised bead having a first height and at least one raised limiter having a second height wherein the second height is shorter than the first height.

7. A product as set forth in claim 6, wherein the at least one raised limiter is generally ribbed shaped.

8. A product as set forth in claim 6, wherein the at least one raised limiter is a plurality of raised limiters.

9. A product as set forth in claim 6, wherein the second height is about 60 micrometers shorter than the first height.

10. A product comprising:
a bipolar plate comprising at least one raised bead having a first height and at least one generally rib shaped raised limiter having a second height wherein the second height is shorter about 60 micrometers shorter than the first height.

11. A product comprising:
a bipolar plate comprising at least one raised bead having a first height and a plurality of raised limiters having a second height wherein the second height is shorter about 60 micrometers shorter than the first height.
